(19) United States
(12) Patent Application Publication
(10) Pub. No.: US 2008/0272920 A1
(43) Pub. Date: Nov. 6, 2008

(54) ANIMAL TRACKING AND CONTAINMENT SYSTEM

(76) Inventor: Stephen J. Brown, Woodside, CA (US)

Correspondence Address: HEALTH HERO NETWORK, INC., 2400 GENG ROAD, SUITE 200, PALO ALTO, CA, 94303, US

(21) Appl. No.: 11/743,490

(22) Filed: May 2, 2007

(51) Int. Cl. A01K 15/02; G08B 21/00

(52) U.S. Cl. 340/573.3; 119/721; 342/357.06

(57) ABSTRACT

A system, apparatus and method for tracking and containing animals within a programmable and customizable confinement area are disclosed. In one embodiment of the invention, a user programmable device is provided that is capable of receiving GPS data, variable inputs, and a rule script. The user-programmable device executes a script generated by a user upon accessing a web-based application stored in a remote server. The rule script includes rules for activation and deactivation of the corrective collar based upon various variable conditions such as proximity to owner, on leash status, time of day or other parameters in addition to boundaries. The remote server is communicatively coupled to said user programmable device and can be accessed by using a user interface for allowing the user to create the rule script.

### BACKGROUND

A. Technical Field

The present invention relates generally to an electronic tracking and containment system and, more particularly to, a web-based user customizable containment system.

B. Background of the Invention

An animal containment system provides electronic fences to keep the animals or pets within defined boundaries. Such a system prevents an animal from escaping out of the boundary. These systems enable a user to design and control the electronic boundary. The electronic boundary acts like an antenna, picking up signals from a transmitter and sending them to pet's receiver/collar. When the pet approaches the boundary, it receives a warning signal (beep). The pet receives a static shock if it moves out of the predefined boundary or the confinement area. As the shock collar is worn around the neck of an animal, it can be used to stimulate that animal to, among other things, encourage or discourage certain behavior such as movement.

Installations of electronic animal containment systems to configure and define confinement area are in great demand. Such systems are subterranean in nature and involve a buried antenna and underground-wired boundary. The buried antenna and underground-wired boundary require excavation of the confinement area boundary, which can damage surrounding grass, flowerbeds and the like. Further, obstacles such as trees, concrete walkways, and driveways hinder the installation process. Moreover, electronic animal containment systems are generally permanent to the location on the land under which the antenna is installed. Fixed location of buried antenna generally blocks future alteration and redefinition of the confinement area. This is impractical because any change in animal location, or traveling to some other place might necessitate the re-installment of the containment system.

Consequently, Global Position Satellite (GPS) systems are being introduced in the confinement systems to overcome the drawbacks of subterranean containment systems. In a GPS-based containment system, the confinement area or boundary can easily be changed and redefined according to one's need. Further, the tracking of animals also become easy.

Typically, the GPS based confinement systems use a wearable pet collar or tag and GPS receiver and transmitter to control and monitor the location and movement of the animal. The collar or tag is generally a battery-operated device that provides an audible or visual signal/warning and electric stimulation in response to a radio frequency signal from a fixed transmitter. The GPS receiver receives signals from multiple satellites in orbit and calculates the position of the receiver based on the signal data. The pet collar or tag worn by the animal helps to track and control movement of animal on the basis of the location of the transmitter unit.

The GPS systems as explained above help in defining a boundary for the pet and tracking the pet's location. A shock capacitor is also provided in the pet collar, which is activated when the pet crosses the boundary defined by the GPS system. However, such integrations of a shock collar with GPS technology lack an ability to sense various conditions in which a shock collar must be deactivated. For example, if the pet is moving out of the predefined boundary with its owner, then the shock collar must be deactivated in order to prevent the pet from receiving the shock. Therefore, the owner has to remove the collar or the tag from the pet or manually deactivate the collar each time he or she takes the pet out of the confinement area.

Unfortunately, the recent solutions existing in the state of art do not have the capability to sense various variable conditions in which the pet collar could be automatically deactivated. Further, the existing GPS technology-based confinement system require complex programming for activating the pet collar and defining the boundary.

Thus there is a need for a new and improved system that is capable of sensing various possible variable conditions and monitors and control animal's location and movement accordingly.

### SUMMARY OF THE INVENTION

The present invention provides a system, apparatus and method for tracking and containing animals within a programmable and customizable boundary.

In one embodiment of the invention, a user programmable device is provided that is capable of receiving GPS data, variable inputs, and a rule script. A remote server having a web-based application is communicatively coupled to the user programmable device. The web-based application may be accessed through a user interface for allowing the user to create the rule script. The rule script contains a set of variable rules based on the variable inputs and a location data series. Said location data series is comprised of mapping data having spatial coordinates. The user programmable device executes the rule script, and the set of variable rules written in the rule script determines the activation and deactivation of said user programmable device.

As per the present invention, the GPS data is received from a GPS source for determining the current location of the device. The GPS data and variable inputs captured in the user programmable device are stored and transmitted back to the server and can be viewed by the user in the web-based application. The web-based application also contains an overlay of publicly available maps.

In one embodiment of the invention the rule script may be programmed to create a virtual boundary for the pet such that the user programmable device is activated when the pet crosses the virtual boundary causing a corrective shock to the pet.

In one embodiment of the invention, the user programmable device is a shock collar worn by a pet. The shock collar may have a leash sensor for detecting the pet in proximity to the pet owner. On detecting the pet in proximity to the pet owner, the shock collar may be deactivated automatically so that the pet does not receive shock while crossing the virtual boundary. The leash sensor causes a variable input to the device for use in the rule script. Said variable inputs include activity, time and date data captured in the device.

The user interface may be a mobile phone, a personal computer, or a personal digital assistant according to the various embodiments of the invention.

In one embodiment of the invention a method for containing a pet within a containment system is provided. The method comprises the steps of providing at least one user programmable device capable of receiving GPS data from a GPS source for determining the current location of the device, providing a web-based application in a remote server that is communicatively coupled to the user programmable device, accessing said web-based application through a user interface for allowing the user to create a rule script containing a set of variable rules based on variable inputs and a location data series, executing said rule script in the user programmable device, and activating and deactivating said user programmable device within the containment system on the basis of said set of variable rules written in the rule script.

In one embodiment of the invention, a user programmable device is provided comprising a receiver for receiving GPS data; means to receive variable inputs from a user; receiver for receiving a rule script containing a set of variable rules, said script being generated by: accessing a web-based application that is stored within a remote server, and using the GPS data and said variable inputs; plurality of sensors for detecting various parameters that are used to create said set of rules; processor for executing the received script and modifying the rules upon analyzing variable inputs and various said parameters; transmitter for sending the status of each rule to said remote server; wherein, said user programmable gets activated or deactivated depending upon the said script within said containment system.

The user programmable device further comprises memory devices for storing various data; a real time clock for providing real time and date; a shock capacitor; light emitting means; sound emitting means; an internal battery; and an accelerometer for measuring the movement and velocity of the pet as well as charging the internal battery.

Other objects, features and advantages of the invention will be apparent from the drawings, and from the detailed description that follows below.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 is a block diagram illustrating an electronic containment system according to one embodiment of the invention.

FIG. 2 is a block diagram of the expanded pet collar module according to one embodiment of the invention.

FIG. 3 illustrates proximity sensing of the pet to the pet owner via Bluetooth communications according to one embodiment of the invention.

FIG. 4 illustrates proximity sensing of the pet to the pet owner by the leash sensor according to one embodiment of the invention.

FIG. 5 shows a virtual boundary that can be programmed according to various embodiments of the invention.

FIG. 6 illustrates the deactivation of shock collar due to proximity to owner or leash sensor.

FIG. 7 shows variable inputs entry screen according to various embodiments of the invention.

FIG. 8 represents a method of activating and deactivating a pet collar device within a containment system as per one embodiment of present invention.

### DETAILED DESCRIPTION OF THE PREFERRED EMBODIMENTS

A system, apparatus and method for tracking and containing animals within a programmable and customizable confinement area are disclosed. In one embodiment of the invention, a user programmable device is provided that is capable of receiving GPS data, variable inputs, and a rule script. The user-programmable device executes the rule script generated by a user upon accessing a web-based application stored in a remote server. The rule script includes rules for activation and deactivation of the user programmable device. Said rules are based upon a data series of locations and various variable inputs including location, time, identity of adjacent person, activity, and any other sensor parameters. The remote server may be communicatively coupled to said user programmable device and may be accessed by using a user interface for allowing the user to create the rule script.

The following description is set forth for purpose of explanation in order to provide an understanding of the invention. However, it is apparent that one skilled in the art will recognize that embodiments of the present invention, some of which are described below, may be incorporated into a number of different computing systems and devices. The embodiments of the present invention may be present in hardware, software or firmware. Structures shown below in the diagram are illustrative of exemplary embodiments of the invention and are meant to avoid obscuring the invention. Furthermore, arrangements of components within the figures are not intended to be limited. Rather, data between these components may be modified, re-formatted or otherwise changed by intermediary components.

Reference in the specification to “one embodiment”, “in one embodiment” or “an embodiment” etc. means that a particular feature, structure, characteristic, or function described in connection with the embodiment is included in at least one embodiment of the invention. The appearances of the phrase “in one embodiment” in various places in the specification are not necessarily all referring to the same embodiment.

A. Overview

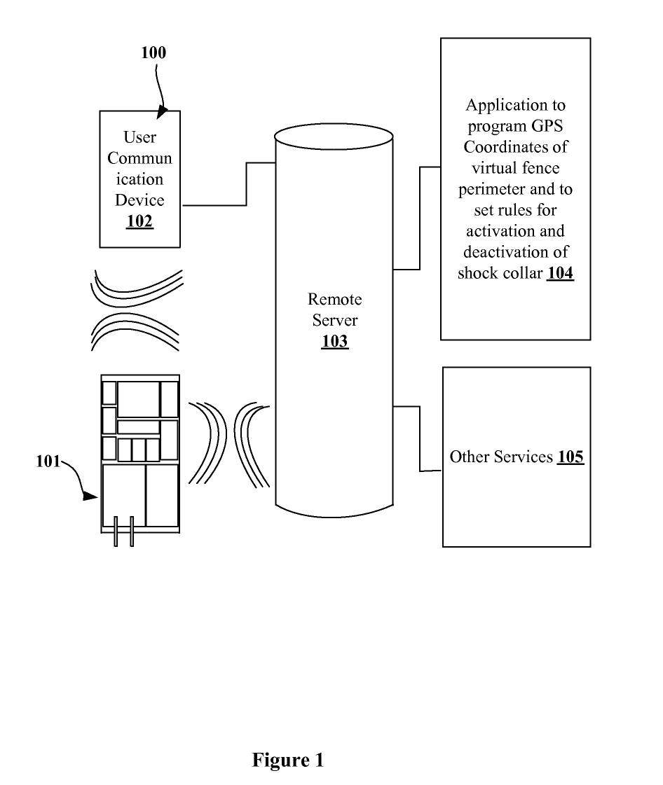

FIG. 1 shows a containment system 100 for tracking the movement of an animal or pet within a confinement area. The system 100 comprises a user programmable device 101 that is capable of receiving GPS data from a GPS source. The GPS data provides the spatial co ordinates, which can be used by a user to create a virtual boundary or the confinement area for the pet. The user programmable device 101 may be preferably a tracking device or a wearable shock collar, which can be worn by the pet around its neck. The data related to the virtual boundary such as location of pet, perimeter length and area required to create the virtual boundary etcetera is fed in to the shock collar such that when the pet tries to move outside the virtual boundary created, it receives a corrective static shock.

The tracking device or the shock collar 101 may be communicatively coupled (e.g. through Bluetooth technology) to a user communication device 102 such as a personal computer, a mobile phone or any other personal digital assistant (PDA). Said user communication device 102 basically serves as an interface for the user so that he/she may download a rule script from a server 103 having a web based application 104. This web-based application 104 allows the user to generate said rule script comprising a set of rules. The programming and customization of the virtual boundary is also based upon the rule script.

The user programmable device 101 may be configured to execute the rule script, and the set of variable rules written in the rule script determines the activation and deactivation of said user programmable device 101. For example, the rule script may contain a rule that describes deactivating of the shock collar when the owner of the pet is in close proximity.

According to an embodiment, the set of variable rules may be based on the variable inputs and a location data series. The variable inputs may be received on the user programmable device 101 or the shock collar. The variable inputs may comprise of pet's activity, pet's proximity to owner, time and date. The location data series may include the mapping data having spatial coordinates obtained from the GPS data. For instance, the web-based application may create an overlay of publicly available maps using GPS application program such as Google™ Earth, which may be translated, into a KML (Keyhole Markup Language) file that can be interpreted by the collar device 101 to display mapping data.

According to the preferred embodiment of the present invention, an example of a KML polygon boundary that can be interpreted by the user programmable device 101 or the pet collar module is as given below:

```
<?xml version=“1.0” encoding=“UTF-8”?>
<kml xmlns=“http://earth.google.com/kml/2.0”>
<Placemark>
  <name>The Pentagon</name>
  <LookAt>
    <longitude>−77.05580139178142</longitude>
    <latitude>38.870832443487</latitude>
    <range>742.0552506670548</range>
      <tilt>48.09646074797388</tilt>
      <heading>59.88865561738225</heading>
    </LookAt>
    <Polygon>
      <extrude>1</extrude>
      <altitudeMode>relativeToGround</altitudeMode>
      <outerBoundaryIs>
      <LinearRing>
        <coordinates>
          −77.05788457660967,38.87253259892824,100
          −77.05465973756702,38.87291016281703,100
          −77.05315536854791,38.87053267794386,100
          −77.05552622493516,38.868757801256,100
          −77.05844056290393,38.86996206506943,100
          −77.05788457660967,38.87253259892824,100
        </coordinates>
      </LinearRing>
    </outerBoundaryIs>
    <innerBoundaryIs>
      <LinearRing>
        <coordinates>
          −77.05668055019126,38.87154239798456,100
          −77.05542625960818,38.87167890344077,100
          −77.05485125901024,38.87076535397792,100
          −77.05577677433152,38.87008686581446,100
          −77.05691162017543,38.87054446963351,100
          −77.05668055019126,38.87154239798456,100
        </coordinates>
      </LinearRing>
    </innerBoundaryIs>
  </Polygon>
</Placemark>
</kml>
```

The web based application may be created by using Ajax, (Asynchronous JavaScript and XML) web development technique so that the entire web application may not have to be reloaded each time the user makes a change in the script. This increases the interactivity, speed, and usability of the system. The AJAX may be used for calling on mapping data services. The application 104 also can display the location and history data from the pet collar device 101 on the user communication device 102 using AJAX calls.

As described earlier, the variable rules written in the rule script determines the activation and deactivation of the shock collar 101 and include various variable conditions relating to the pet and the pet owner. For instance the rule script may contain the status of owner's proximity to the pet, leash status, time of day or other parameters in addition to boundaries.

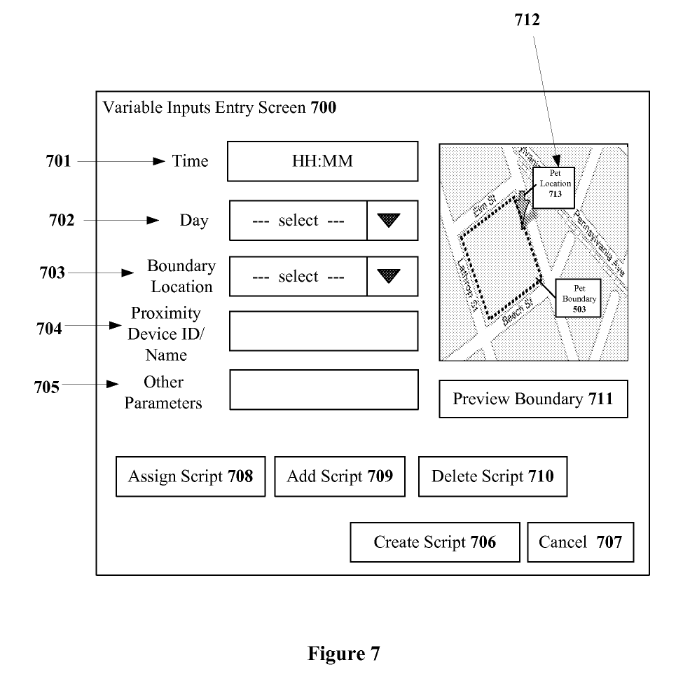

The web-based application 104 may be a controlling software application executed by the server 103 to perform the various functions including script generation as described below. The application 104 may include a script generator (not shown). The script generator may be designed to generate the rule script from script information entered through the user programmable device 101 or the pet collar 101. The script information may be entered through a variable inputs entry screen 700 (of FIG. 7) that can be displayed on the user interface or the user communication device 102. In one embodiment, the variable inputs entry screen 700 (of FIG. 7) may also be implemented as a web page on the server 103. The user communication device 102 may also include a web browser for accessing the web page to enter the variable inputs and script information.

The remote server 103 may also be communicatively coupled to the shock collar 101 and may be accessed by the user communication device 102 or a user interface as explained above. The automatic deactivation of the corrective collar 101 is based on the set of rules that can be programmed by the owner by accessing the variable inputs entry screen 700 (of FIG. 7). As explained earlier, one of the parameters of these rules may include proximity to the owner. When the leash of the pet is put on the pet's collar, or the animal is in close proximity to the owner, the animal is able to cross the boundary without receiving any shock.

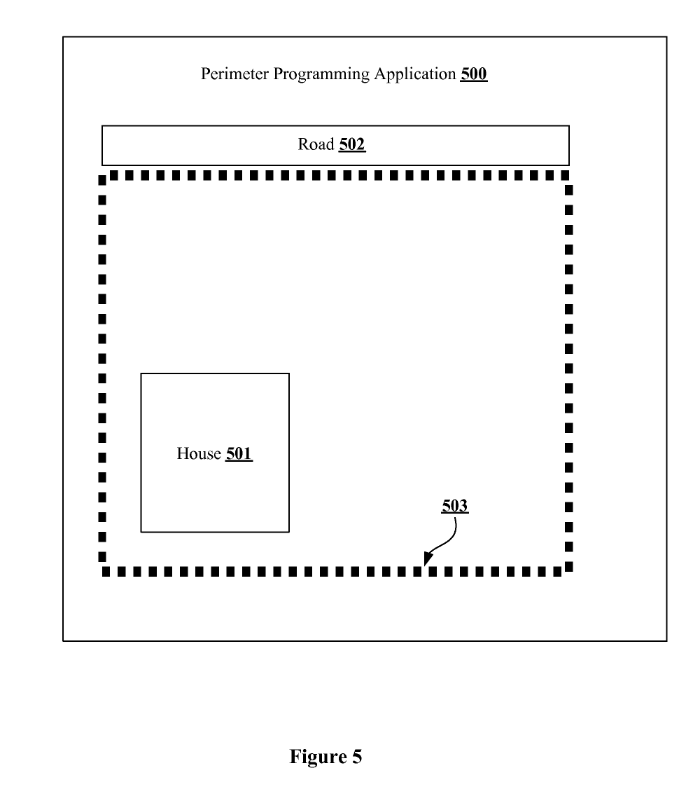

The user programmable device 101 may receive GPS signal from a GPS source for obtaining spatial co ordinates. The user programmable device 101 may further transmit these coordinates to the remote server 103. These coordinates may be used to define the virtual boundary 503 (of FIG. 5) or the confinement area of the pet. The coordinates may be transmitted continually in real time to the remote server 103. Or alternatively, the coordinates may be stored in memory of the programmable device 101 and can be transmitted subsequently to the remote server 103.

Apart from locating the pet on the basis of programmed virtual boundary based GPS coordinates 104, the above explained system 100 can also be used for providing other services 105 such as monitoring and managing a chronic or persistent medical condition of the animals.

The user programmable device 101 may also use various other sensors including sensors for measuring pulse, temperature, respiration monitor, wetness etc. Various medical sensors of interest may also be provided within the user programmable device (shock collar) 101 to provide a system for monitoring and managing a chronic or persistent medical condition of the animal.

B. Pet Collar Module

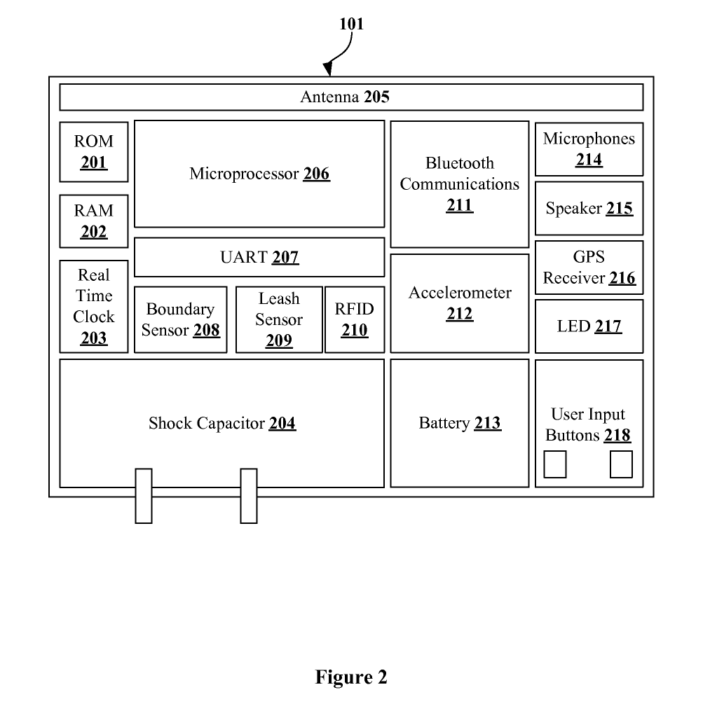

FIG. 2 shows a block diagram of pet collar module device 101 according to the preferred embodiment of the invention.

The pet collar module 101 comprises a battery-operated microprocessor 206 along with a receiver and a transmitter circuitry. The transmitter and receiver circuitries include a GPS receiver 216, an antenna 205, UART 207 and Bluetooth Communication devices 214 as shown in the figure. The GPS receiver 216 receives GPS signals from a GPS source. The pet collar module 101 may also be also configured to receive updated rule script from a remote server 103 (of FIG. 1). The transmitter circuit transmits GPS data received from the GPS source, to the remote server 103 (of FIG. 1). This data is transmitted via RF transmissions using the RF Identifier (RFID) 210.

The pet collar module 101 further comprises an accelerometer 212 that detects the movement of the pet and measures the velocity of said movement. The position of the pet and change of the velocity of the pet's movement are continuously monitored at the remote server 103 (of FIG. 1) to ascertain whether the change in position or the velocity is normal or unusual. This helps in tracking the pet moving out of the predefined virtual boundary

When the pet approaches within a predetermined distance of the programmed boundary, the sensors provided on the pet collar 101 detect various conditions and the detection is indicated on the pet collar module 101 through various indicators provided, such as a LED 217 for flashing visual light and/or a speaker 215 for producing a beep or music. A microphone 214 can also be provided with the pet collar module 101 to record the cries of the pet, which can also be used for the tracking of the pet.

The pet collar module 101 is a programmable device and the programming is based upon various variable inputs, hence, means to receive variable inputs from a user are also provided. For example, as shown in FIG. 2, various input buttons 218 may be provided to enable a user enter various inputs in the pet collar module 101. A user may further use these variable inputs and the GPS data to create a rule script. As mentioned earlier, the rule script may be generated by the user upon accessing a web-based application that is stored within a remote server 103 (of FIG. 1).

Further, the pet collar module 101 contains a plurality of sensors such as boundary sensor 208 and leash sensor 209 for detecting various parameters that are used to create said set of rules. The processor 206 basically performs the function of executing the received script and modifying the rules upon analyzing variable inputs and various said parameters. Said processor 206 is supported with basic software and basic hardware such as ROM 201, RAM 206, Real-Time Clock 203 and rechargeable battery 213.

As stated earlier, the status of each rule may be continuously transmitted to the remote server 103 (of FIG. 1) for the enablement of the animal tracking and monitoring task and the entire collar module 101 gets activated or deactivated depending upon the rules written in the rule script. When the pet collar module 101 is in activated state, the boundary sensor 208 continuously detects the movement of the pet with respect to the virtual boundary defined by the user. As the pet moves along the boundary, the boundary sensor 208 detects whether the pet is within the confinement area or not. As soon as the pet moves out of the boundary, the shock collar 101 gives a corrective static shock to the pet. The static shock is produced from a shock capacitor 204 provided in the pet collar module 101.

The leash sensor 209 is provided for detecting the proximity of the pet owner to the pet. The microprocessor 206 processes the output-data of the boundary sensor 208, leash sensor 209 and the accelerometer. A rechargeable battery 213 is also provided for supplying power to the pet collar module 101.

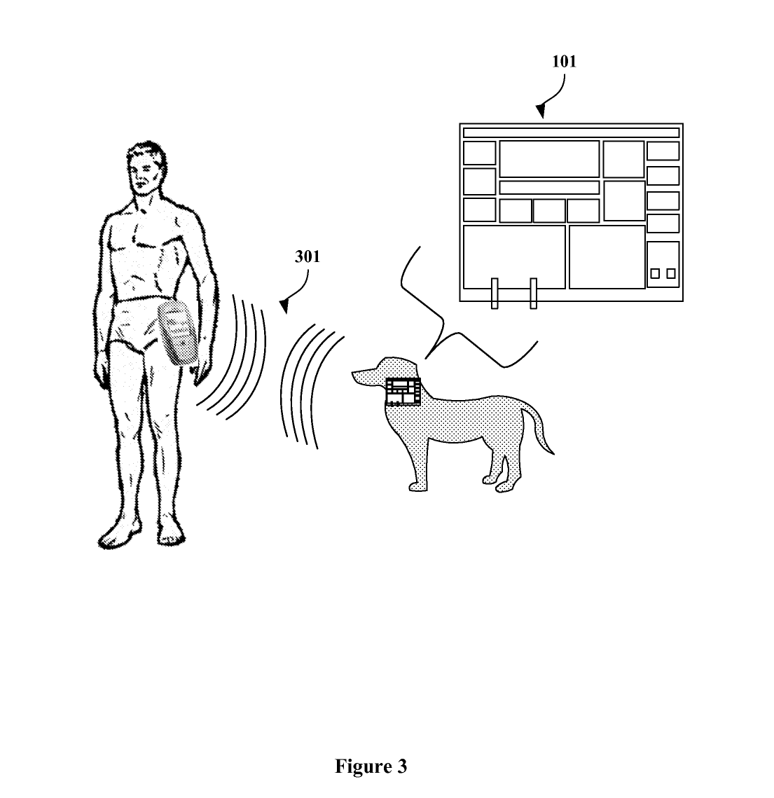

The present invention will now be explained through various examples as shown in FIG. 3 to FIG. 8.

FIG. 3 illustrates proximity sensing of the pet to the pet owner via Bluetooth communication 301 according to one embodiment of the invention. As shown in the figure, and as explained earlier the pet collar module 101 has the capability to sense the owner in proximity to the pet through Bluetooth communication device present in the pet collar module 101. This is achieved by providing a Bluetooth communication device in the pet collar module 101. The pet collar module 101 gets deactivated when the owner is in proximity to the pet.

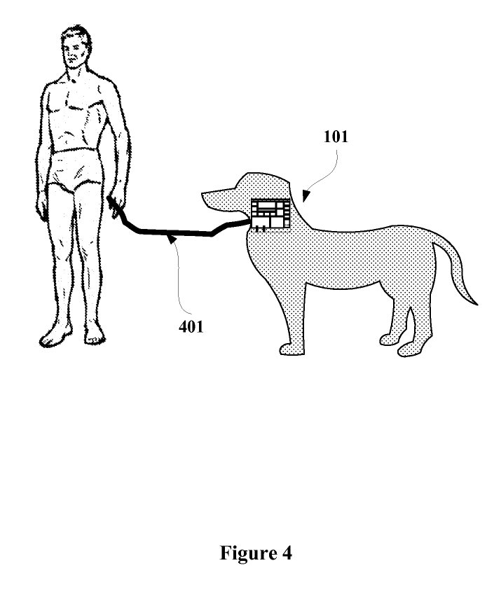

Similarly, FIG. 4 illustrates proximity sensing of the pet to the pet owner through the leash sensor. The pet collar module 101 has a leash sensor, which detects the presence of the owner if the owner is holding the leash 401. The pet collar module 101 gets deactivated when the leash sensor detects owner in proximity to the pet.

FIG. 5 shows a virtual boundary 503 that can be programmed by perimeter programming application 500. The user accesses the programming application 500 via an interface and based on various variable inputs and GPS data received by the pet collar module, the user defines the virtual boundary 503. The perimeter programming application enables a user or pet owner to create a virtual boundary 503 between the pet's house 501 and the outside road 502. When the pet collar 101 module is activated, the pet might receive a shock if it tries to cross this boundary 503 provided the pet is not in proximity to the owner.

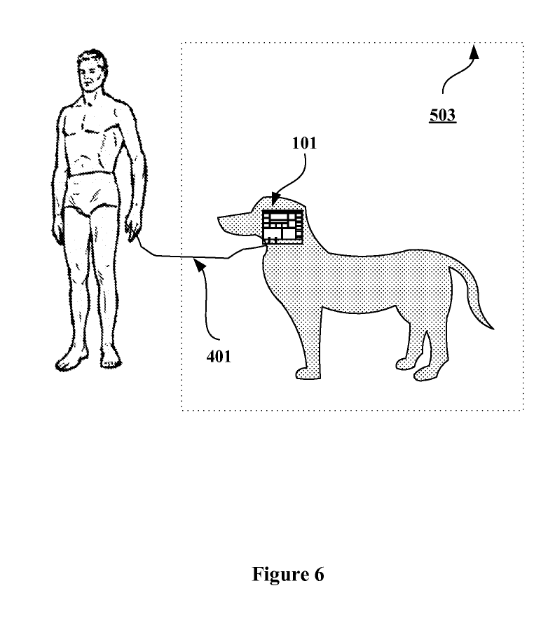

FIG. 6 illustrates the deactivation of shock collar 101 due to proximity to owner. When the owner holds the leash 401 of the pet, the pet collar module 101 gets deactivated and static shock is not given to the pet even if it crosses the virtual boundary 503 that is created and programmed by the owner.

FIG. 7 shows variable inputs entry screen according to various embodiments of the invention. A user or the pet owner may enter various variable inputs for creating rules and programming the shock collar 101. The virtual boundary 503 for the pet may be created and the shock collar 101 may be activated and deactivated based on these rules. The pet collar or the pet device 101 may execute the rules by establishing a communication link to the server 103.

The variable inputs entry screen 700 may allow a user to enter various input parameters such as time 701, day 702, boundary location 703, proximity device ID/Name 704 and other parameters 705. Inputs related to the time and day may enable the pet device or the shock collar 101 to get activated/deactivated at the required time/date entered. The boundary location input 703 may allow a user to set the virtual boundary 503 of the pet as per the requirement. The boundary location input 703 may include the location of pet, perimeter length and area required to create the virtual boundary 503. The boundary location input 703 may also include the mapping data having spatial coordinates obtained from the GPS data. The input relating to proximity device ID/Name 704 may include the device ID or name of the leash sensor or owner device so that when the owner having that device comes in proximity to the pet, the pet device 101 may identify the device and may get activated or deactivated accordingly.

The variable inputs entry screen 700 may include a CREATE SCRIPT button 706 for generating the rule script from the information entered in screen 700. The variable inputs entry screen 700 may also include a CANCEL button 707 for canceling the information entered in screen 700.

The variable inputs entry screen 700 may also include an ASSIGN SCRIPT 708 button for assigning the required rule script on the user programmable device 101. The screen 700 may also include an ADD SCRIPT button 709 for accessing the variable inputs entry screen 700 and a DELETE SCRIPT button 710 for deleting a rule script. A preview boundary button 711 may also be provided to allow the user to view the virtual boundary and the pet location. The preview 712 shows a perimeter 503 that can be set automatically by the mapping application. The preview 712 also shows the location 713 of the pet that can be calculated by the GPS application program such as Google™ Earth. The data related to the perimeter 503 and the location 713 of the pet may be translated, into a KML file that can be interpreted by the collar device 101 according to various embodiments of the invention.

Thus the activating or deactivating the user programmable device 101 may be programmed based on time, location, crossing a boundary, and proximity to another person or device.

The preferred embodiment herein, describes a pet containment system, wherein by automatically activating the pet device, a pet may be tracked if it crosses a virtual boundary created by the user. Also the pet device may be deactivated if the pet is in proximity to the owner. Another embodiment could be a patient at a dementia facility going outside of a boundary either with or without being attended by a nurse. When the device goes outside of the boundary at the wrong time and without being attended by someone, an alarm may be activated. If the person is attended, then the alarm my not be activated.

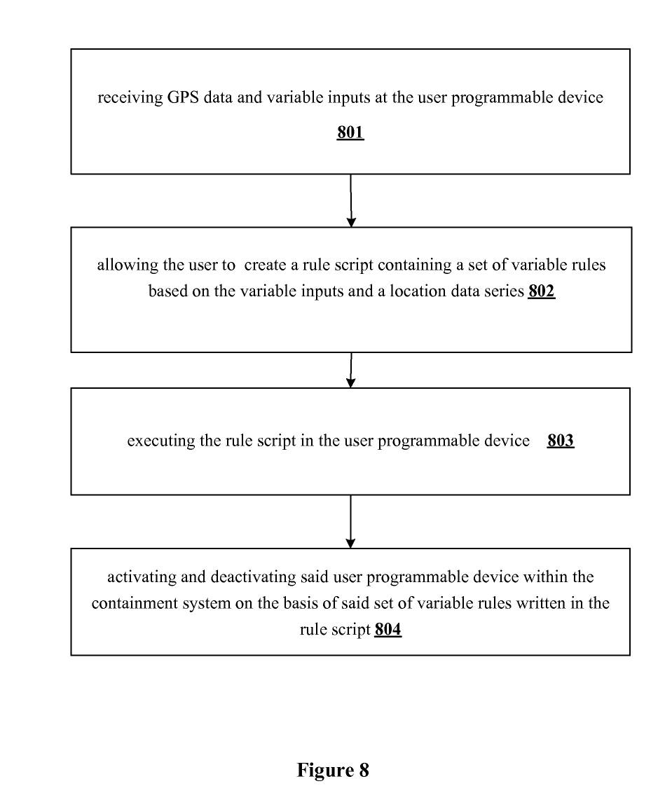

FIG. 8 represents a method of activating and deactivating a pet collar device within a containment system as per one embodiment of present invention. The method provides activating and deactivating of a pet collar device automatically without user or pet owner involvement. Various parameters that are precisely and timely measured are received at the user programmable device 801. These parameters include GPS data received from a GPS source, and variable inputs comprising pet's activity, owner proximity to the pet, time and date. The GPS data provides location data series that helps in determining the current location of pet wearing the programmable device. The location data series is basically the mapping data having spatial coordinates obtained from the GPS data. The user programmable device may be made available to the user for programming the device to create a rule script containing a set of variable rules based on the variable inputs and a location data series 802.

The method further involves executing the rule script in the user programmable device 803. The user programmable device executes the rule script by establishing a communication link to the remote server 103 (of FIG. 1). As soon as the link is established, and the rule script is executed, said user programmable device within the containment system is activated or deactivated on the basis of said set of variable rules written in the rule script 804.

The foregoing description of the invention has been described for purposes of clarity and understanding. It is not intended to limit the invention to the precise form disclosed. Various modifications may be possible within the scope and equivalence of the appended claims.

What is claimed is:

1. A containment system comprising:
at least one user programmable device having an owner proximity sensor and capable of receiving:
GPS data from a GPS source for determining the current location of the device,
variable inputs including owner proximity data received from said owner proximity sensor, and
a rule script;
a remote server having a web-based application, the remote server being communicatively coupled to said user programmable device;
a user interface capable of accessing said web-based application for allowing the user to create a rule script containing a set of variable rules based on variable inputs and a location data series;
wherein, said user programmable device executes the rule script, and the set of variable rules written in the rule script determines the activation and deactivation of said user programmable device.

2. The containment system of claim 1 wherein the GPS data and variable inputs captured in the device are stored and transmitted back to the server and can be viewed by the user in the web-based application.

3. The containment system of claim 1, wherein the web-based application contains an overlay of publicly available maps.

3. The containment system of claim 1, wherein the location data series is mapping data having spatial coordinates.

4. The containment system of claim 1, wherein the user programmable device is a shock collar worn by a pet.

5. The containment system of claim 4, wherein the rule script is programmed to create a virtual boundary for the pet.

6. The containment system of claim 5, wherein the rule script is programmed to activate the device when the pet crossing the virtual boundary.

7. The containment system of claim 5, wherein the rule script activate the device when the pet crosses the boundary causing a shock to the pet.

8. The containment system of claim 4, wherein the shock collar has a leash sensor for detecting the pet in proximity to the pet owner.

9. The containment system of claim 8, wherein the shock collar is deactivated when the leash sensor detects the pet in proximity to the pet owner.

10. The containment system of claim 9, wherein deactivation of the shock collar allows the pet to move outside the virtual boundary without receiving a shock.

11. The containment system of claim 8, wherein the leash sensor causes a variable input to the device for use in the rule script.

12. The containment system of claim 6, wherein said set of variable rules is based upon the boundary sensor output.

13. The containment system of claim 1, wherein said variable inputs is comprised of activity, owner proximity data, time and date data captured in the device.

14. The containment system of claim 1, wherein said user interface is a mobile phone.

15. The containment system of claim 1, wherein said user interface is a personal computer.

16. The containment system of claim 1, wherein said user interface is a personal device assistant.

17. A method for containing a pet within a containment system, the method comprising the steps of:
providing at least one user programmable device having an owner proximity sensor and capable of receiving:
GPS data from a GPS source for determining the current location of the device,
variable inputs including owner proximity data received from said owner proximity sensor, and
a rule script;
providing a web based application within a remote server that is communicatively coupled to the user programmable device;
accessing said web-based application through a user interface for allowing the user to:
create a rule script containing a set of variable rules based on variable inputs and a location data series;
executing said rule script in the user programmable device; and
activating and deactivating said user programmable device within the containment system on the basis of said set of variable rules written in the rule script.

18. The method of claim 17, wherein the GPS data and variable inputs captured in the device are stored and transmitted back to the server and can be viewed by the user in the web-based application.

19. The method of claim 17, wherein the web-based application contains an overlay of publicly available maps.

20. The method of claim 17, wherein the location data series is mapping data having spatial coordinates.

21. The method of claim 17, wherein the user programmable device is a shock collar worn by a pet.

22. The method of claim 17, wherein the rule script is programmed to create a virtual boundary for the pet.

23. The method of claim 17, wherein the rule script is programmed to activate the device when the pet crosses the virtual boundary.

24. The method of claim 17, wherein the rule script activate the device when the pet crosses the boundary causing a shock to the pet.

25. The method of claim 21, wherein the shock collar has a leash sensor for detecting the pet in proximity to the pet owner.

26. The method of claim 21, wherein the shock collar is deactivated when the leash sensor detects the pet in proximity to the pet owner.

27. The method of claim 21, wherein deactivation of the shock collar allows the pet to move outside the virtual boundary without receiving a shock.

28. The method of claim 26, wherein the leash sensor causes a variable input to the device for use in the rule script.

29. The method of claim 17, wherein said set of variable rules is based upon the boundary sensor output.

30. The method of claim 17, wherein said variable inputs is comprised of activity, owner proximity data, time and date data captured in the device.

31. The method of claim 17, wherein said user interface is a mobile phone.

32. The method of claim 17, wherein said user interface is a personal computer.

33. The method of claim 17, wherein said user interface is a personal device assistant.

33. A user programmable device being used in a containment system, the device comprising:
receiver for receiving GPS data;
means to receive variable inputs from a user;
receiver for receiving a rule script containing a set of variable rules, said script being generated by:
accessing a web-based application that is stored within a remote server, and
using the GPS data and said variable inputs;
boundary sensor for sensing virtual boundary predefined by the rule script;
a leash sensor for sensing the proximity to owner;
plurality of sensors for detecting various parameters that are used to create said set of rules;
processor for executing the received script and modifying the rules upon analyzing variable inputs and various said parameters;
transmitter for sending the status of each rule to said remote server;
wherein, said user programmable gets activated or deactivated depending upon the said script within said containment system.

34. The user programmable device of claim 33, further comprising:
memory devices for storing various data;
a real time clock for providing real time and date;
a shock capacitor;
light emitting means;
sound emitting means;
an internal battery; and
an accelerometer for charging the internal battery.
